(19) United States
(12) Patent Application Publication
(10) Pub. No.: US 2026/0043687 A1
(43) Pub. Date: Feb. 12, 2026

(54) METHOD FOR CALCULATING FORMATION TEMPERATURE OF MINERAL BASED ON CHLORITE SPECTRUM

(71) Applicants: Tibet Julong Copper Co., Ltd., Lhasa (CN); CHINA UNIVERSITY OF GEOSCIENCES (BEIJING), Beijing (CN)

(72) Inventors: Xian CHE, Lhasa (CN); Xingkai HUANG, Lhasa (CN); Gen CHEN, Lhasa (CN); Song WU, Beijing (CN); Deng PAN, Lhasa (CN); Xiaofang DOU, Beijing (CN); Xiaojia JIANG, Beijing (CN); Yitao HOU, Beijing (CN); Bei PANG, Beijing (CN)

(73) Assignees: Tibet Julong Copper Co., Ltd., Lhasa (CN); CHINA UNIVERSITY OF GEOSCIENCES (BEIJING), Beijing (CN)

(21) Appl. No.: 19/364,123

(22) Filed: Oct. 21, 2025

(30) Foreign Application Priority Data
Oct. 23, 2024 (CN) 202411485110.1

(51) Int. Cl. G01J 5/58; G01J 5/53; G01N 21/3563; G01N 21/359

(52) U.S. Cl. CPC G01J 5/58; G01J 5/53; G01N 21/3563; G01N 21/359

(57) ABSTRACT

A method for calculating a formation temperature of a mineral based on a chlorite spectrum includes: S1, recording characteristic data of each chlorite sample; S2, acquiring a Fe—OH wavelength value of each chlorite sample; S3, calculating a formation temperature of and contents of major elements in each chlorite sample; and S4, according to the formation temperature and major element contents obtained in the step S3, determining a formation environment and a category of a corresponding chlorite sample. The calculation of a formation temperature of a chlorite mineral is based on characteristic wavelength parameters acquired by field short-wave infrared spectroscopy instead of traditional calculation based on major element data acquired by laboratory electron microprobe analysis (EMPA), which facilitates the rapid identification of a formation environment and an alteration zone of a mineral and greatly improves a working efficiency of mineral exploration.

### CROSS-REFERENCE TO RELATED APPLICATION

This application claims priority to Chinese Patent Application No. 202411485110.1 with a filing date of Oct. 23, 2024. The content of the aforementioned application, including any intervening amendments thereto, is incorporated herein by reference.

### TECHNICAL FIELD

The present disclosure relates to the field of mineral exploration and evaluation, and in particular to a method for calculating a formation temperature of a mineral based on a chlorite spectrum.

### BACKGROUND

Chlorite minerals widely form in different geological environments, and the genesis of chlorite minerals includes magmatic hydrothermal and metamorphic geneses. Chlorite minerals can form in environments with a medium-high temperature, a medium-low temperature, and a low temperature. Especially in porphyry deposits, chlorite minerals can form in both high-temperature sericitic alteration zones and low-temperature propylitic alteration zones. Therefore, the accurate and rapid identification of a formation temperature of chlorite is of prominent guiding significance for the subsequent mineral exploration.

The existing method for calculating a formation temperature of mineral is as follows: based on the major element data obtained by electron microprobe analysis (EMPA) or the trace element data obtained by laser ablation-inductively coupled plasma-mass spectrometry (LA-ICP-MS) analysis, a formation temperature of a mineral is calculated by an empirical formula of a mineral temperature, such as a biotite and amphibole Ti temperature gauge, a chlorite Al temperature gauge, a zircon Zr saturation temperature gauge, a Ti temperature gauge, and a rutile Zr temperature gauge. In the above method, EPMA analysis and LA-ICP-MS analysis are required before a temperature is calculated, and both EPMA analysis and LA-ICP-MS analysis have characteristics such as a long cycle and a high cost, which cannot meet the urgent needs of economy and efficiency in the current mineral exploration processes.

### SUMMARY

In view of this, the present disclosure provides a method for quantitatively calculating a formation temperature of a mineral based on a characteristic parameter of a short-wave infrared spectrum of chlorite (a Fe—OH wavelength), which can provide a basis for the rapid identification of a formation environment and an alteration zone of the mineral, so as to guide the subsequent mineral exploration deployment.

A method for calculating a formation temperature of a mineral based on a chlorite spectrum is provided, including the following steps:
S1, collecting chlorite samples, and recording characteristic data of each chlorite sample;
S2, conducting short-wave infrared spectroscopy for each chlorite sample to obtain a Fe—OH wavelength value of each chlorite sample;
S3, with an absorption peak value at a Fe—OH wavelength of chlorite as a threshold value, calculating a formation temperature of the chlorite sample and contents of major elements in the chlorite sample when the Fe—OH wavelength value is larger than or smaller than the absorption peak value; and
S4, according to temperature and major element content information obtained in the S3, determining a formation environment and a category of a corresponding chlorite sample.

Further, in the S3, the absorption peak value at the Fe—OH wavelength of the chlorite is 2,255 nm;
if a Fe—OH wavelength value of a chlorite sample measured in the S2 is smaller than or equal to 2,255 nm, a formation temperature of the chlorite sample is calculated by the following equation (1):

$$T ( ° C . ) = 8 \text{.5475} * Pos 2250 - 18994 \pm 50 \qquad ( 1 )$$

where Pos2250 represents a Fe—OH wavelength value of a chlorite sample; and

if a Fe—OH wavelength value of a chlorite sample measured in the S2 is larger than 2,255 nm, a formation temperature of the chlorite sample is calculated by the following equation (2):

$$T ( ° C . ) = 8 \text{.7646} * Pos 2250 - 19609 \pm 50 \qquad ( 2 )$$

where Pos2250 represents a Fe—OH wavelength value of a chlorite sample.

Further, in the S3, the major elements in each chlorite sample are Fe, Mg, and Si.

Further, in the S3, the absorption peak value at the Fe—OH wavelength of the chlorite is 2,255 nm;
if a Fe—OH wavelength value of a chlorite sample measured in the S2 is smaller than or equal to 2,255 nm, contents of the major elements Fe, Mg, and Si in the chlorite sample are calculated by equations (3) to (5), respectively, where an equation for calculating a content of Fe is as follows:

$$Fe ( apfu ) = 0.0783 * Pos 2250 - 174.41 \pm 0.5 \qquad ( 3 )$$

where Pos2250 represents a Fe—OH wavelength value of a chlorite sample; and
an equation for calculating a content of Mg is as follows:

$$Mg ( apfu ) = - 0.0949 * Pos 2250 + 216.25 \pm 0.5 \qquad ( 4 )$$

where Pos2250 represents a Fe—OH wavelength value of a chlorite sample; and
an equation for calculating a content of Si is as follows:

$$Si ( apfu ) = - 0.0494 * Pos 2250 + 114.14 \pm 0.2 \qquad ( 5 )$$

where Pos2250 represents a Fe—OH wavelength value of a chlorite sample; and
if a Fe—OH wavelength value of a chlorite sample measured in the S2 is larger than 2,255 nm, contents of the major elements Fe, Mg, and Si in the chlorite sample are calculated by equations (6) to (8), respectively, where an equation for calculating a content of Fe is as follows:

$$Fe ( apfu ) = 0.25 * Pos 2250 - 560.91 \pm 0.5 \qquad ( 6 )$$

where Pos2250 represents a Fe—OH wavelength value of a chlorite sample; and
an equation for calculating a content of Mg is as follows:

$$Mg ( apfu ) = - 0.161 ⋆ Pos 2250 + 364.78 \pm 0.5 \qquad ( 7 )$$

where Pos2250 represents a Fe—OH wavelength value of a chlorite sample; and
an equation for calculating a content of Si is as follows:

$$Si ( apfu ) = - 0.0696 ⋆ Pos 2250 + 160.19 \pm 0.2 \qquad ( 8 )$$

where Pos2250 represents a Fe—OH wavelength value of a chlorite sample.

Further, in the S4, based on a calculation result of a formation temperature T of each chlorite sample in the S3, if 200° C.≤T≤300° C., the chlorite sample forms in a medium-high temperature environment, and when 100° C.<T<200° C., the chlorite sample forms in a medium-low temperature environment.

Further, the S4 further includes determining a category of each chlorite sample based on ranges of contents of Fe and Si in the chlorite sample obtained in the S3.

The technical solution provided by the present disclosure has the following beneficial effects: In the method for calculating a formation temperature of a mineral based on a chlorite spectrum of the present disclosure, the calculation of a formation temperature of a chlorite mineral is the calculation based on characteristic wavelength parameters acquired by field short-wave infrared spectroscopy instead of the traditional calculation based on major element data acquired by laboratory EMPA, which facilitates the rapid identification of a formation environment and an alteration zone of a mineral and greatly improves a working efficiency of mineral exploration.

### BRIEF DESCRIPTION OF THE DRAWINGS

FIG. 1 is a flow chart showing a method for calculating a formation temperature of a mineral based on a chlorite spectrum of the present disclosure;

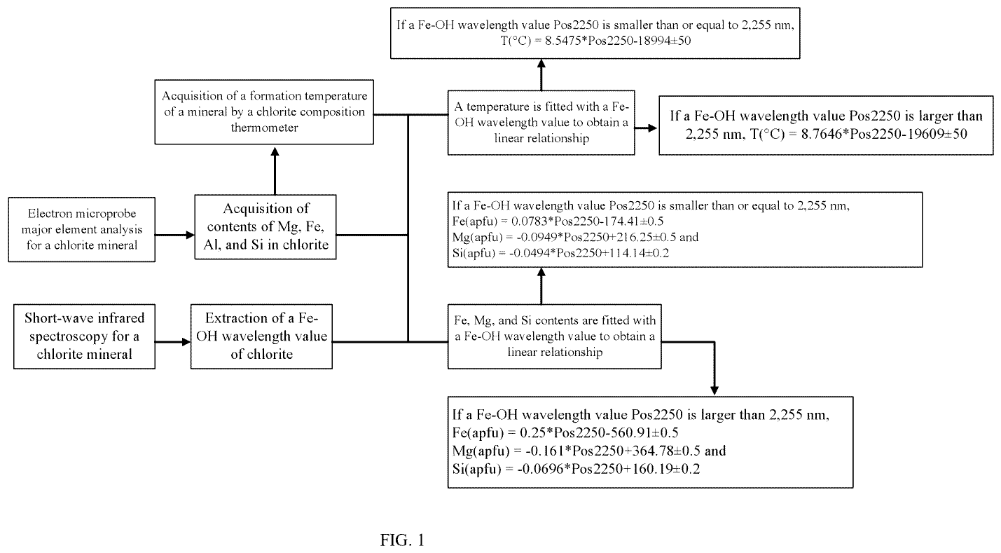

FIG. 2 shows correlation analysis results, where (a) is a chart showing correlation analysis between a Fe—OH wavelength and a formation temperature of chlorite in the present disclosure; (b) is a chart showing correlation analysis between a Fe—OH wavelength and a Fe content of chlorite in the present disclosure; (c) is a chart showing correlation analysis between a Fe—OH wavelength and a Mg content of chlorite in the present disclosure; and (d) is a chart showing correlation analysis between a Fe—OH wavelength and a Si content of chlorite in the present disclosure; and

FIG. 3 is a classification chart showing chlorite compositions in the present disclosure.

### DETAILED DESCRIPTION OF THE EMBODIMENTS

In order to make the objectives, technical solutions, and advantages of the present disclosure clear, the implementations of the present disclosure will be further described below in conjunction with the accompanying drawings.

Chlorite is composed of tetrahedrons and octahedrons alternately. A chemical formula of a main component in chlorite is Y₃[Z₄O₁₀](OH)₂; Y₃(OH)₆, where Y mainly represents Mg²⁺, Fe²⁺, Al³⁺, and Fe³⁺ and Z mainly represents Si and Al. With the change of a physicochemical environment, chlorite will undergo some replacements, for example, Si and Al^{IV} at tetrahedral positions and Al^{IV}, Mg, Fe²⁺, and Fe³⁺ at octahedral positions can be replaced to cause a composition change of chlorite. Studies have shown that, when Mg is replaced with Fe in an octahedron and Si is replaced with Al in a tetrahedron in chlorite to increase Fe and Al contents, a Fe—OH wavelength (Pos2250) of chlorite can increase, and a change of a formation temperature of chlorite is also mainly controlled by changes of Fe, Mg, and Al contents in a mineral. Therefore, based on a relationship of a characteristic wavelength and a temperature change of chlorite with a mineral composition, it is feasible to establish a method for calculating a formation temperature of a chlorite mineral based on a short-wave infrared spectrum.

Specifically, the present disclosure discloses a method for calculating a formation temperature of a mineral based on a chlorite spectrum, including the following steps:

S1: Chlorite samples are collected, and characteristic data of each chlorite sample is recorded. The characteristic data of each chlorite sample includes collection coordinates, a lithologic characteristic, a chlorite characteristic (veined or disseminated), mineralization, and a location of the chlorite sample. S2: Short-wave infrared spectroscopy is conducted for each chlorite sample to obtain a Fe—OH wavelength value of each chlorite sample. In the present disclosure, a Fe—OH wavelength value of a sample can be tested with a test instrument such as a portable short-wave infrared spectrometer (TerraSpec).

S3: With an absorption peak value at a Fe—OH wavelength of chlorite as a threshold value, a formation temperature of the chlorite sample and contents of major elements in the chlorite sample when the Fe—OH wavelength value is larger than or smaller than the absorption peak value are calculated. A derivation process of calculation equations for a formation temperature and major element contents of each chlorite sample is as follows:

S31: Collection of data samples: Short-wave infrared spectroscopy data and EMPA major element data for chlorite related to magmatic-hydrothermal ore deposits are acquired through Chinese and English literature databases such as CNKI and WEB of SCIENCE to obtain the data samples.

### S32: Calculation of Chlorite Formation Temperatures

Based on differences in contents of the major elements Fe, Mg, and Al in chlorite, a formation temperature of a chlorite mineral is calculated by a chlorite temperature calculation equation. That is, a formation temperature of a chlorite mineral is calculated based on contents of Al^{IV}, Fe, and Mg in laboratory EMPA data, where Fe═Fe²⁺+Fe³⁺. A specific calculation equation is as follows:

$$T ( ° C . ) = 212.4 ( {Al}^{IV} - 0.44 ( \frac{Fe}{F e + M g} - 0.34 ) ) + 17.5$$

where Al^{IV} represents a Al content in chlorite calculated based on 14 oxygen atoms, Fe represents a Fe content in chlorite, and Mg represents a Mg content in chlorite. It should be noted that the chlorite temperature calculation equation of the present disclosure is the prior art.

### S33: Correlation Analysis

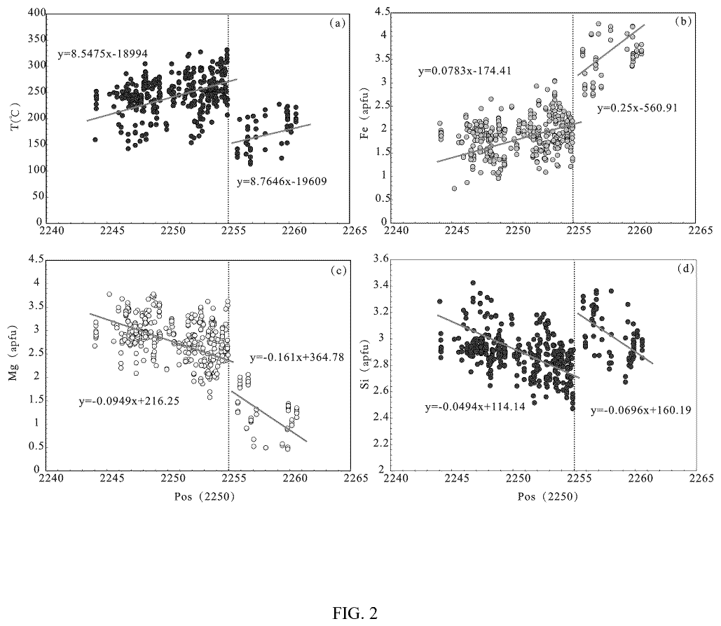

With a Fe—OH wavelength (Pos2250) in a short-wave infrared spectrum for chlorite in a data sample as an x-coordinate and with a formation temperature and Mg, Fe, and Si contents for chlorite calculated in the S32 as y-coordinates, a scatter diagram is plotted in the Excel, and the correlation between a Fe—OH wavelength and a chlorite composition is analyzed. Results are shown in FIG. 2. It can be seen from (b) to (d) of FIG. 2 that a Fe—OH wavelength (Pos2250) of chlorite is positively correlated with a Fe content, negatively correlated with a Mg content, and negatively correlated with a Si content. It indicates that, when Mg is replaced with Fe in an octahedron and Si is replaced with Al in a tetrahedron in chlorite to cause the increase of a Fe content and the decrease of a Si content, a Fe—OH wavelength (Pos2250) of chlorite can increase. It can be seen from (a) of FIG. 2 that a Fe—OH wavelength (Pos2250) of chlorite is positively correlated with a temperature. Mg-rich and iron-poor chlorite forms at a relatively-low temperature, and has a Fe—OH wavelength (Pos2250) dominated by short waves. Fe-rich and Mg-poor chlorite forms at a relatively-high temperature, and has a Fe—OH wavelength (Pos2250) dominated by long waves.

### S34: Acquisition of Equations for Calculating a Formation Temperature and Major Element Contents of Chlorite

Further analysis shows that a Fe—OH wavelength of chlorite exhibits inconsistent correlations with a formation temperature and major element contents of chlorite in different wave bands, which is related to the fact that a change of a short-wave infrared spectral wavelength for chlorite is controlled by many factors. In the present disclosure, a Fe—OH wavelength value (Pos2250) of 2,255 nm as a characteristic parameter in an infrared spectrum for chlorite is taken as a threshold value, and according to correlation analysis results in the S3, Fe—OH wavelength data of chlorite is linearly fitted with formation temperature data of chlorite to obtain the following equations for calculating a formation temperature of chlorite with a Fe—OH wavelength larger than or smaller than 2,255 nm:

When a Fe—OH wavelength Pos2250 of chlorite interpreted from a field test is smaller than or equal to 2,255 nm, an equation for calculating a formation temperature of the chlorite is as follows: T (° C.)=8.5475*Pos2250−18994±50.

When a Fe—OH wavelength Pos2250 of chlorite interpreted from a field test is larger than 2,255 nm, an equation for calculating a formation temperature of the chlorite is as follows: T(° C.)=8.7646*Pos2250−19609±50.

Similarly, a Fe—OH wavelength of chlorite is linearly fitted with contents of the major elements Fe, Mg, and Si in chlorite to obtain the following equations for calculating contents of Fe, Mg, and Si in chlorite with a Fe—OH wavelength larger than or smaller than 2,255 nm:

When a Fe—OH wavelength Pos2250 of chlorite interpreted from a field test is smaller than or equal to 2,255 nm:

An equation for calculating a Fe content in the chlorite is as follows:

$$Fe ( apfu ) = 0.0783 ⋆ Pos 2250 - 174.41 \pm 0.5 .$$

An equation for calculating a Mg content in the chlorite is as follows:

$$Mg ( apfu ) = - 0.0949 ⋆ Pos 2250 + 216.25 \pm 0.5 .$$

An equation for calculating a Si content in the chlorite is as follows: Si(apfu)=−0.0494*Pos2250+114.14±0.2.

When a Fe—OH wavelength Pos2250 of chlorite interpreted from a field test is larger than 2,255 nm:

An equation for calculating a Fe content in the chlorite is as follows:

$$Fe ( apfu ) = 0.25 ⋆ Pos 2250 - 560.91 \pm 0.5 .$$

An equation for calculating a Mg content in the chlorite is as follows:

$$Mg ( apfu ) = - 0.161 ⋆ Pos 2250 + 364.78 \pm 0.5 .$$

An equation for calculating a Si content in the chlorite is as follows: Si(apfu)=−0.0696*Pos2250+160.19±0.2.

### S4: a Formation Environment and a Category of Chlorite are Determined.

Based on a calculation result of a formation temperature T of chlorite in the S4: If 200° C.≤T≤300° C., it can be determined that the chlorite forms in a medium-high temperature environment, such as a sericitic alteration zone. When 100° C.<T<200° C., it can be determined that the chlorite forms in a medium-low temperature environment, such as a propylitic alteration zone.

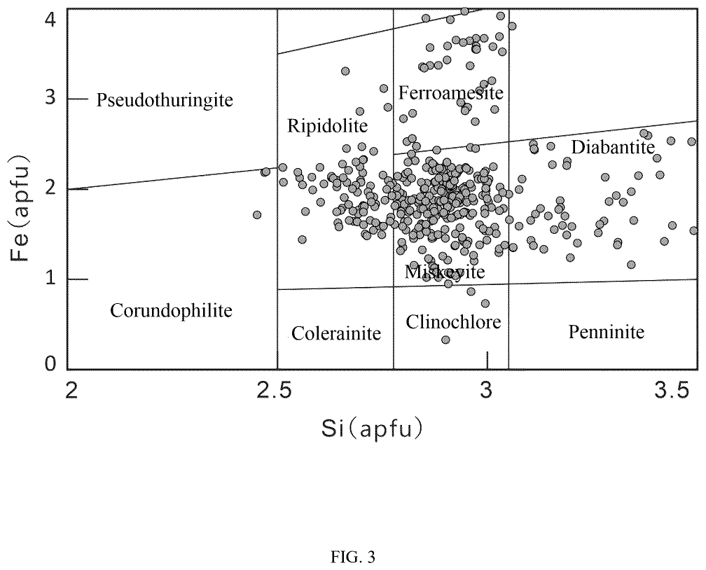

Based on calculation results of Si and Fe contents of chlorite in the S4, a classification chart of chlorite compositions is plotted (Si vs. Fe), as shown in FIG. 3. According to ranges of Fe and Si contents, chlorite can be classified as corundophilite, pseudothuringite, ripidolite, colerainite, clinochlore, miskeyite, ferroamesite, diabantite, or penninite. It should be noted that the categories of chlorite in the present disclosure belong to the prior art, and criteria for the classification can refer to the relevant literature Wiewióra and Weiss, 1990; Inoue et al., 2009.

In the method for calculating a formation temperature of a mineral based on a chlorite spectrum of the present disclosure, the calculation of a formation temperature of a chlorite mineral is the calculation based on characteristic wavelength parameters acquired by field short-wave infrared spectroscopy instead of the traditional calculation based on major element data acquired by laboratory EMPA, which facilitates the rapid identification of a formation environment and an alteration zone of a mineral and greatly improves a working efficiency of mineral exploration.

### Example 1

The method for calculating a formation temperature of a mineral based on a chlorite spectrum in the present disclosure was used to calculate a formation temperature of a chlorite mineral in a Zhuno porphyry deposit, including the following steps:
a. Geological mapping: The production characteristics of outcropping chlorite on a surface of the Zhuno deposit were identified through mapping, including veined, disseminated, and clumpy characteristics.
b. Collection of field samples: Chlorite-containing samples were collected at the Zhuno deposit. During a sample collection process, the following information was truthfully recorded in detail:

| Sample | | | Lithologic | Chlorite | | |
|---|---|---|---|---|---|---|
| No. | X | Y | characteristic | characteristic | Mineralization | Location |
| 10101-1 | 547907 | 3281087 | Monzonitic | Disseminated | Minor pyrite | Zhuno |
| | | | granite | | mineralization | |
| | | | porphyry | | | |
| 1301-1 | 545227 | 3281026 | Monzonitic | Veined | None | Zhuno |
| | | | granite | | | |
| 4033-1 | 543992 | 3280278 | Quartz | Clumpy | Minor | Zhuno |
| | | | porphyry | | chalcopyrite | |
| | | | | | mineralization | |
| . . . | . . . | . . . | . . . | . . . | . . . | . . . |

c. Sample Testing: Each collected chlorite-containing sample was tested by a portable short-wave infrared spectrometer (TerraSpec) in the field.
d. Data processing: The obtained spectral data was interpreted by the spectral interpretation software (TSG) to extract a Fe—OH wavelength (Pos2250). Interpretation results showed that Fe—OH wavelengths (Pos2250) of chlorite samples collected in the Zhuno deposit varied from 2,248 nm to 2,255 nm.
e. Calculation of mineral formation temperature and composition: The spectral characteristic of chlorite interpreted for the Zhuno deposit met a condition (1): a Fe—OH wavelength Pos2250 of chlorite interpreted from a field test was smaller than or equal to 2,255 nm, and the following data are calculated:

With the chlorite spectral thermometer: T(° C.)=8.5475*Pos2250−18994±50, a formation temperature was calculated, which varied from 207° C. to 346° C.

With the equation for calculating a Fe content in chlorite: Fe(apfu)=0.0783*Pos2250−174.41±0.5, a Fe content was calculated, which varied from 1.2 apfu to 2.3 apfu.

With the equation for calculating a Mg content in chlorite: Mg(apfu)=−0.0949*Pos2250+216.25±0.5, a Mg content was calculated, which varied from 2.5 apfu to 3.6 apfu.

With the equation for calculating a Si content in chlorite: Si(apfu)=−0.0494*Pos2250+114.14±0.2, a Si content was calculated, which varied from 2.5 apfu to 3.1 apfu.
f. Determination of a formation environment and a category of chlorite:

According to the above temperature and composition calculation results, it was determined that chlorite samples collected in the Zhuno deposit formed in a medium-high temperature environment, were mainly the products of sericitic alteration, and were mainly classified as ripidolite and miskeyite. The above determination results are basically consistent with the results of microscopic identification and the results of EMPA, which proves that the method proposed by the present disclosure is effective.

The technical solution provided by the present disclosure has the following beneficial effects: In the method for calculating a formation temperature of a mineral based on a chlorite spectrum of the present disclosure, the calculation of a formation temperature of a chlorite mineral is the calculation based on characteristic wavelength parameters acquired by field short-wave infrared spectroscopy instead of the traditional calculation based on major element data acquired by laboratory EMPA, which facilitates the rapid identification of a formation environment and an alteration zone of a mineral and greatly improves a working efficiency of mineral exploration.

The above embodiments and the features in the embodiments herein may be combined with each other in a non-conflicting situation.

The above are merely preferred embodiments of the present disclosure, and are not intended to limit the present disclosure. Any modifications, equivalent replacements, improvements, and the like made within the spirit and principle of the present disclosure shall be all included in the protection scope of the present disclosure.

What is claimed is:

1. A method for calculating a formation temperature of a mineral based on a chlorite spectrum, comprising the following steps:
S1, collecting chlorite samples, and recording characteristic data of each chlorite sample;
S2, conducting short-wave infrared spectroscopy for each chlorite sample to obtain a Fe—OH wavelength value of each chlorite sample;
S3, with an absorption peak value at a Fe—OH wavelength of chlorite as a threshold value, respectively calculating a formation temperature (T) of the chlorite sample and contents of major elements in the chlorite sample when the Fe—OH wavelength value is larger than or no larger than the absorption peak value; and
S4, according to the formation temperature (T) and the contents of major elements obtained in the step S3, determining a formation environment and a category of a corresponding chlorite sample; when 200° C.≤T=300° C., determining that the chlorite sample is formed in a medium-high temperature environment, and when 100° C.<T<200° C., determining that the chlorite sample is formed in a medium-low temperature environment.

2. The method according to claim 1, wherein in the step S3, the absorption peak value at the Fe—OH wavelength of the chlorite is 2,255 nm;
when the Fe—OH wavelength value of the chlorite sample measured in the step S2 is smaller than or equal to 2,255 nm, the formation temperature (T) of the chlorite sample is calculated by the following equation (1):
$$T ( ° C . ) = 8.5475 ⋆ Pos 2250 - 18994 \pm 50 \qquad ( 1 )$$
wherein Pos2250 represents the Fe—OH wavelength value of the chlorite sample; and
when the Fe—OH wavelength value of the chlorite sample measured in the step S2 is larger than 2,255 nm, the formation temperature (T) of the chlorite sample is calculated by the following equation (2):
$$T ( ° C . ) = 87646 ⋆ Pos 2250 - 19609 \pm 50 \qquad ( 2 )$$
wherein Pos2250 represents the Fe—OH wavelength value of the chlorite sample.

3. The method according to claim 1, wherein in the step S3, the major elements in each chlorite sample are Fe, Mg, and Si.

4. The method according to claim 3, wherein in the step S3, the absorption peak value at the Fe—OH wavelength of the chlorite is 2,255 nm;
when the Fe—OH wavelength value of the chlorite sample measured in the step S2 is smaller than or equal to 2,255 nm, the contents of the major elements Fe, Mg, and Si in the chlorite sample are calculated by equations (3) to (5), respectively, wherein an equation for calculating a content of Fe is as follows:
$$Fe ( apfu ) = 0.0783 ⋆ Pos 2250 - 174.41 \pm 0.5 \qquad ( 3 )$$
wherein Pos2250 represents the Fe—OH wavelength value of the chlorite sample;
an equation for calculating a content of Mg is as follows:
$$Mg ( apfu ) = - 0.0949 ⋆ Pos 2250 + 216.25 \pm 0.5 \qquad ( 4 )$$
wherein Pos2250 represents the Fe—OH wavelength value of the chlorite sample; and
an equation for calculating a content of Si is as follows:
$$Si ( apfu ) = - 0 \text{.049} ⋆ Pos 2250 + 114.14 \pm 0.2 \qquad ( 5 )$$
wherein Pos2250 represents the Fe—OH wavelength value of the chlorite sample; and
when the Fe—OH wavelength value of the chlorite sample measured in the step S2 is larger than 2,255 nm, the contents of the major elements Fe, Mg, and Si in the chlorite sample are calculated by equations (6) to (8), respectively, wherein an equation for calculating a content of Fe is as follows:
$$Fe ( apfu ) = 0.25 ⋆ Pos 2250 - 560.91 \pm 0.5 \qquad ( 6 )$$
wherein Pos2250 represents the Fe—OH wavelength value of the chlorite sample; and
an equation for calculating a content of Mg is as follows:
$$Mg ( apfu ) = - 0.161 ⋆ Pos 2250 + 364.78 \pm 0.5 \qquad ( 7 )$$
wherein Pos2250 represents the Fe—OH wavelength value of the chlorite sample; and
an equation for calculating a content of Si is as follows:
$$Si ( apfu ) = - 0.0696 ⋆ Pos 2250 + 160.19 \pm 0.2 \qquad ( 8 )$$
wherein Pos2250 represents the Fe—OH wavelength value of the chlorite sample.

5. The method according to claim 1, wherein the step S4 further comprises: determining a category of each chlorite sample based on ranges of contents of Fe and Si in the chlorite sample obtained in the step S3.
